(19) United States
(12) Patent Application Publication
(10) Pub. No.: US 2008/0291696 A1
(43) Pub. Date: Nov. 27, 2008

(54) Integrated Light Guide Panel and Method of Manufacturing the Same

(75) Inventors: Ji-Gon Kim, Anyang-city (KR); Min-Cheol Kook, Yongin-city (KR); Kwang-Won Kim, Sungnam-city (KR); Sang-Do Lee, Yongin-city (KR)

Correspondence Address: SUGHRUE MION, PLLC, 2100 PENNSYLVANIA AVENUE, N.W., SUITE 800, WASHINGTON, DC, 20037, US

(73) Assignee: DOOSAN CORPORATION, SEOUL (KR)

(21) Appl. No.: 12/159,461

(22) PCT Filed: Dec. 22, 2006
(86) PCT No.: PCT/KR2006/005667

§ 371 Date: Jun. 27, 2008

(30) Foreign Application Priority Data
Dec. 30, 2005 (KR) 10-2005-0135304

(51) Int. Cl. F21V 7/04; B05D 5/06

(52) U.S. Cl. 362/623; 427/164

(57) ABSTRACT

An integrated light guide panel for use in a backlight unit for an LCD and a method for manufacturing the same are disclosed. The integrated light guide panel includes a light guide panel for guiding light, to form surface light, a reflective coating layer arranged beneath the light guide panel, to reflect light emerging from a lower surface of the light guide panel such that the light is again incident to the light guide panel, a diffusive coating layer arranged over the light guide panel, to diffuse light emerging from the light guide panel, a prism coating layer arranged over the diffusive coating layer, to concentrate light emerging from the diffusive coating layer, and low refractive coating layers respectively arranged between the light guide panel and the reflective coating layer and between the light guide panel and the diffusive coating layer.

### TECHNICAL FIELD

The present invention relates to an integrated light guide panel for use in a backlight unit for an LCD and a method for manufacturing the same, and more particularly to an integrated light guide panel in which a light guide panel and a diffusion plate adapted to guide and diffuse light are integrally formed via reflection plates, and a method for manufacturing the same.

### BACKGROUND ART

Generally, LCDs are known as a display device configured to allow the user to recognize information processed by an information processor by precisely controlling the light transmittance of liquid crystals in accordance with the electro-optical characteristics of the liquid crystals.

Such an LCD includes a liquid crystal display assembly for realizing an image or information by controlling liquid crystals, and a backlight unit for supplying light to enable the user to view the image or information realized on the liquid crystal display assembly.

Meanwhile, the performance of an image display using an optical film is greatly influenced by the performance of the backlight unit used in the image display.

This is because the image display mainly uses a system for controlling the amount of light used in the image display by reflecting or transmitting the light via the optical film. For effective application of a thin optical film to an image display, various optical films exhibiting excellent optical performance have been proposed.

FIG. 1 is a simple structure of a backlight unit for a general LCD.

Referring to FIG. 1, a light source 11 for supplying light to an LCD is shown. For the light source 11, a light emitting diode (LED) or a cold cathode fluorescent lamp (CCFL) which is a kind of a discharge lamp may be used.

A light guide panel 13 is used in the LCD, in order to convert linear light or point light into uniform surface light.

The light guide panel 13 forms uniform surface light while guiding light incident to one or both side surfaces of the light guide panel 13. The surface light is uniformly diffused by a diffusion sheet 14 arranged over the light guide panel 13, so the uniformity of the light is enhanced. A reflection sheet 12 is arranged beneath the light guide panel 12, to reflect light emerging from the lower surface of the light guide panel 13 such that the reflected light is again incident to the light guide panel 13.

First and second prism sheets 15 and 16 are arranged over the diffusion sheet 14, to concentrate light emerging from the diffusion sheet 14, and thus to achieve an enhancement in brightness. A protection sheet 17 is arranged over the second prism sheet 16, to protect the prism sheet 16. A thin film display 18 is arranged at the uppermost portion of the LCD.

The prism sheets 15 and 16 are arranged to be orthogonal to each other. Each of the prism sheets 15 and 16 is a flexible thin optical film which functions as a light concentrating sheet. Such a flexible thin optical film is made of a transparent polymer material, and has a structured surface at one surface and a smooth surface at the other surface.

The structured surface of the optical film includes a linear arrangement of small isosceles-triangular prisms arranged in parallel to form a plurality of peaks and valleys extending throughout the length of the optical film.

The light guide panel 13 and diffusion sheet 14 may be prepared by injection molding a melted resin composition or extruding the melted resin composition through an extruder, passing the injection-molded or extruded product through a nip defined between polishing rollers such that the product has a plate shape, cooling the rolled product, and cutting the cooled product into a desired size.

In particular, the light guide panel 13 is prepared by cutting a plate-shaped substrate generally made of a PMMA or PC material into a desired size, and printing a pattern of dots on a lower surface of the cut substrate using a diffusion ink. The printing is carried out such that the density of dots increases gradually as the dots are spaced away from a light source, to cause light incident to the light guide panel 13 to be scattered and diffusedly reflected, and thus to provide uniform brightness.

For the manufacture of such a conventional backlight unit, however, it is necessary to use a plurality of processes for arranging the reflection sheet 12 beneath the light guide panel prepared as mentioned above, and sequentially arranging the diffusion plate 14, and prism sheets 15 and 16.

Furthermore, in the conventional backlight unit, there is a problem in that wrinkles may be formed in the sheets due to the internal heat generated from the light source 11 arranged near the backlight unit and external humid environments, so blemishes are generated.

### DISCLOSURE OF INVENTION

### Technical Problem

Therefore, the present invention has been made in view of the above problems, and it is an object of the present invention to provide an integrated light guide panel, in which a light guide panel and a diffusion plate are integrally formed, a method for manufacturing the same, which are capable of reducing the number of assembly processes for a backlight unit, and thus achieving improvements in workability and quality.

Another object of the present invention is to provide an integrated light guide panel and a method for manufacturing the same, which are capable of preventing the generation of blemishes caused by wrinkles which may be generated at sheets due to the internal heat generated in an LCD and external humid environments.

### Technical Solution

In accordance with an aspect, the present invention provides an integrated light guide panel comprising: a light guide panel for guiding light, to form surface light; a reflective coating layer arranged beneath the light guide panel, to reflect light emerging from a lower surface of the light guide panel such that the light is again incident to the light guide panel; a diffusive coating layer arranged over the light guide panel, to diffuse light emerging from the light guide panel; a prism coating layer arranged over the diffusive coating layer, to concentrate light emerging from the diffusive coating layer; and low refractive coating layers respectively arranged between the light guide panel and the reflective coating layer and between the light guide panel and the diffusive coating layer.

The low refractive coating layers may have a refractive index lower than a refractive index of the light guide panel arranged adjacent to the low refractive coating layers.

The low refractive coating layer may have a refractive index of about 1.3 to 1.45.

The low refractive coating layers may be made of a thermosetting or UV-setting resin selected from a polysiloxane resin, a fluorine-containing polysiloxane resin, trifluoroacrylate, and a silicon-based resin.

Each of the low refractive coating layer may contain low refractive particulates.

The low refractive particulates may be selected from CaF₂, NaF, Na₃AlF₆, SiOₓ, AlF₃, LiF, and MgF₂.

Each of the low refractive coating layers may have a thickness of about 5 to 30□.

The diffusive coating layer may contain transparent particle for scattering light.

The integrated light guide panel may further comprise a protection film arranged beneath the reflective coating layer or over the prism coating layer.

In accordance with another aspect, the present invention provides a method for manufacturing an integrated light guide panel, comprising: performing a printing process on one surface of a light guide panel, to form a light-scattering dot pattern on the surface of the light guide panel; forming a first low refractive coating layer over the dot pattern printed on the light guide panel; forming a reflective coating layer over the first low refractive coating layer; forming a second low refractive coating layer over the other surface of the light guide panel; forming a diffusive coating layer over the second low refractive coating layer; and forming a prism coating layer over the diffusive coating layer.

The method may further comprise cutting the manufactured integrated light guide panel into a predetermined size.

The step of forming the refractive coating layer may comprise coating a resin composition containing a reflection agent over the first low refractive coating layer.

The step of forming the diffusive coating layer may comprise coating a resin composition over the second low refractive coating layer, and drying the coated resin composition.

The step of forming the prism coating layer may comprise coating a resin composition over the diffusive coating layer such that a structured pattern is formed.

The method may further comprise attaching a protection film to a lower surface of the reflective coating layer or to an upper surface of the prism coating layer.

### ADVANTAGEOUS EFFECTS

In accordance with the present invention, it is possible to obtain an integrated light guide panel, in which a light guide panel and a diffusion plate are integrally formed, to reduce the number of assembly processes for a backlight unit, and thus to achieve improvements in workability and quality.

In accordance with the present invention, it is also possible to prevent the generation of blemishes caused by wrinkles that may be generated in sheets due to the internal heat generated in an LCD and external humid environments.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a backlight unit for illuminating an LCD panel;

FIG. 2 is a schematic sectional view of an integrated light guide panel according to the present invention;

FIG. 3 is a flow chart illustrating processes for manufacturing an integrated light guide panel in accordance with the present invention;

FIGS. 4a to 4g are schematic sectional views illustrating structures formed in the manufacturing processes for the integrated light guide panel according to the present invention; and

FIG. 5 is a schematic view illustrating a cutting process for cutting the integrated light guide panel manufactured in accordance with the present invention into a certain product size.

### DESCRIPTION OF REFERENCE NUMERALS

11: light source 12: reflection sheet
13: light guide panel 14: diffusion sheet
15, 16: prism sheet 17: protection sheet
18: display 20, 21: low refractive coating layer
22: reflective coating layer 23: light guide panel
24: diffusive coating layer 25: prism coating layer
26: particle 27: dot pattern
28: protection sheet

### BEST MODE FOR CARRYING OUT THE INVENTION

Hereinafter, exemplary embodiments of the present invention will be described in detail with reference to the annexed drawings.

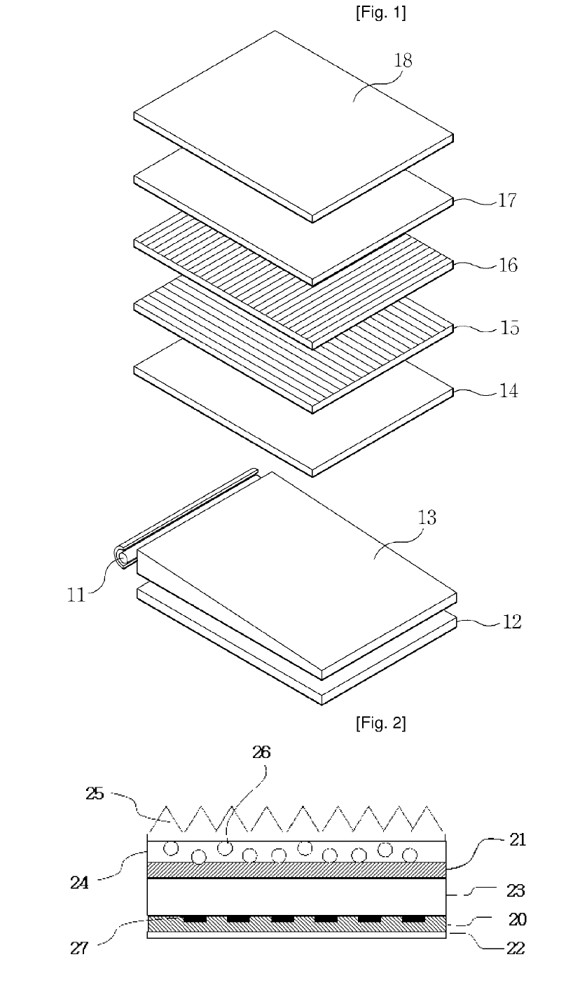

FIG. 2 is a schematic sectional view illustrating an integrated light guide panel according to an embodiment of the present invention.

Referring to FIG. 2, the integrated light guide panel according to the present invention includes a light guide panel 23 for guiding light emitted from a point light source, or a linear light source, to form surface light. The integrated light guide panel also includes a reflective coating layer 22 arranged beneath the light guide panel 23, to reflect light emerging from a lower surface of the light guide panel 23 such that the reflected light is again incident to the light guide panel 23, a diffusive coating layer 24 arranged over the light guide panel 23, to diffuse light emerging from the light guide panel 23, and a prism coating layer 25 arranged over the diffusive coating layer 24, to concentrate light emerging from the diffusive coating layer 24.

A dot pattern 27 is printed on the lower surface of the light guide panel 23, to guide light while causing diffused reflection or scattering of the light.

The integrated light guide panel according to the present invention further includes low refractive coating layers 20 and 21 respectively arranged between the light guide panel 23 and the reflective coating layer 22 and between the light guide panel 23 and the diffusive coating layer 24. The reflective coating layer 22, diffusive coating layer 24, prism coating layer 25, and light guide panel 23 are integrally formed.

The prism coating layer 25 is adapted to provide a light concentration function. The prism coating layer 25 may be formed by transferring a structured pattern having prism structures to an oligomer resin layer, using a mold formed with the structured pattern, and curing the resin layer in accordance with UV irradiation.

The low refractive coating layers 20 and 21 of the integrated light guide panel according to the present invention have a refractive index lower than the refractive index of the light guide panel arranged adjacent to the layers 20 and 21 (1.54 in the case of PMMA). Preferably, the low refractive coating layers 20 and 21 are made of a material having a refractive index of 1.3 to 1.45, to achieve a full reflection function during light reflection or light transfer.

Each of the low refractive coating layers 20 and 21 may have a composition including a polysiloxane resin, a fluorine-containing polysiloxane resin, trifluoroacrylate, or a silicon-based resin as a thermosetting or UV-setting resin. The composition may further include low refractive particulates, or may be mixed with other additives.

The low refractive particulates may include CaF₂ (refractive index of 1.23), NaF (refractive index of 1.29), Na₃AlF₆ (refractive index of 1.33), SiOₓ (refractive index of 1.35 to 1.48), AlF₃ (refractive index of 1.38), LiF (refractive index of 1.4), or MgF₂ (refractive index of 1.4).

Preferably, the diffusive coating layer 24 of the integrated light guide panel according to the present invention contains transparent particle 26 for scattering light reflected from the light guide panel 23.

The particle achieves light uniformity by scattering light in a travel path of the light.

A protection film 28 is also arranged beneath the reflective coating layer 22 such that the protection film 28 is in contact with the reflective coating layer 22.

### MODE FOR THE INVENTION

Hereinafter, the integrated light guide panel according to the present invention and the manufacturing method thereof will be described in detail in conjunction with examples.

Various compositions were prepared by adding 5 parts of a photoinitiator to respective low refractive resins of AR110 (product name of DAIKIN Co., Ltd.) having a refractive index of 1.34, LRI-3 (product name of KONGYOUNG Co., Ltd.) having a refractive index of 1.38, TU2085 (product name of JSR Co., Ltd.) having a refractive index of 1.41, and LC0007 (product name of DSM Co., Ltd.) having a refractive index of 1.43.

Low refractive resin layers were coated over upper and lower surfaces of a light guide panel to a thickness of 1 to 50□, using each composition.

When each low refractive resin layer has a thickness of less than 5□, a degradation in optical effect occurs. On the other hand, when each low refractive resin layer has a thickness of more than 30□, it is difficult to achieve desired thinness of the product. In this case, a degradation in transmissivity also occurs. Accordingly, it is preferred that the low refractive resin layers have a thickness of 5 to 30□.

After the coating process, the coated low refractive resin layers were cured in accordance with UV irradiation using an UV amount of 500 mJ/cm².

Thereafter, a composition was prepared by dispersing acrylic resin particulates having an average grain size of 20□ in an amount of 200 parts by weight based on the weight of acrylic resin in 150 parts by weight of methyl ethyl ketone. The prepared composition was coated over each light guide panel sample to a thickness of 5 to 30□, and then was cured.

Subsequently, the following composition was coated over the resultant sample:

Urethane acrylate 10 parts by weight;

Epoxy acrylate 37 parts by weight;

Dipentaerythritol pentaacrylate+Dipentaerythritol hexaacrylate

13 parts by weight;

Ethoxylated 10 Bisphenol A acrylate 30 parts by weight;

Photoinitiator (Product Name: TPO) 3 parts

A master engraved with prism structures was pressed against the coated layer which was, in turn, subjected to UV irradiation using a UV lamp (100 W/cm²), to transfer the prism structures to the coated layer.

Thus, the integrated light guide panel samples using the above-described low refractive resins were obtained. Each integrated light guide panel sample had the following brightness and uniformity.

TABLE 1

| Low Refractive Resin | Brightness (cd/m²) | Uniformity |
|---|---|---|
| AR110 (Refractive Index of 1.34) | 2,890 | 87% |
| LRI-3 (Refractive Index of 1.38) | 2,863 | 87% |
| TU2085 (Refractive Index of 1.34) | 2,726 | 79% |
| LC0007 (Refractive Index of 1.34) | 2,719 | 78% |

Hereinafter, the manufacturing method for the integrated light guide panel according to the present invention will be described.

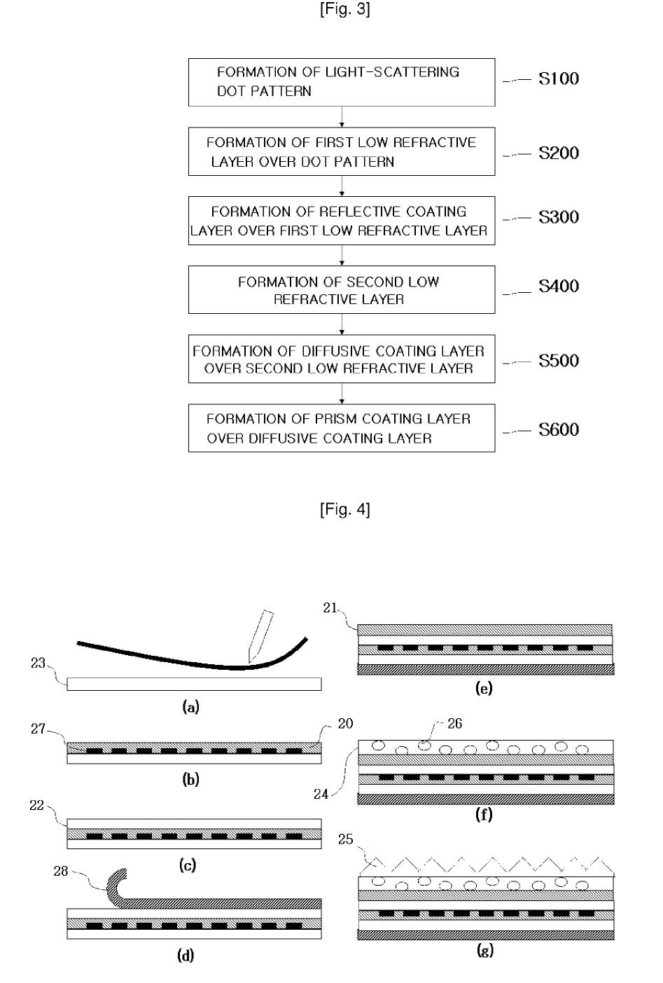

FIG. 3 is a flow chart illustrating processes for manufacturing the integrated light guide panel in accordance with an embodiment of the present invention. FIGS. 4a to 4g are schematic sectional views illustrating structures formed in the manufacturing processes for the integrated light guide panel according to the present invention.

The integrated light guide panel of the present invention, in which the diffusive coating layer 24, reflective coating layer 22, and prism coating layer 25 are integrally formed, is manufactured as follows.

First, formation of a light-scattering dot pattern 27 is carried out by performing a printing process on one surface of the light guide panel 23 (S100).

As shown in FIG. 4a, the dot pattern 27 is printed on one surface of the light guide panel 23 such that printed dots have a pitch enabling light emerging downwardly from the light guide panel 23 to be upwardly reflected and scattered. Practically, the printing process is carried out for a large-size PMMA plate corresponding to the light guide panel which has not been cut into a desired final product size yet.

Second, formation of the first low refractive coating layer 20 over the dot pattern 27 printed on the light guide panel 23 is carried out in accordance with a coating process (S200).

As shown in FIG. 4b, the first refractive coating layer 20 is a refractive layer formed between the light guide panel 23 and the reflective coating layer 22, to induce full reflection of light at interfaces. The first refractive coating layer 20 is made of a material having a refractive index lower than PMMA.

Third, formation of the reflective coating layer 22 over the first low refractive coating layer 20 is carried out (S300).

As shown in FIG. 4c, the formation of the reflective coating layer 22 may be achieved by coating a resin composition containing a reflection agent over the first low refractive coating layer 21. The coated layer is cured in accordance with UV irradiation.

In addition, a protection sheet 28 may be attached to protect the lower reflective coating layer 22, as shown in FIG. 4d.

This process may be carried out in the same manner as in addition of a protection sheet for protecting the prism coating layer 25.

Fourth, formation of a second low refractive coating layer 21 having the same refractive index and composition conditions as those of the first low refractive coating layer 20 over the other surface of the light guide panel 23 is carried out (S400).

As shown in FIG. 4e, this process is achieved by turning over the light guide panel 23 subjected to the above-described processes, and coating the second low refractive coating layer 21 over an upper surface of the light guide panel 23 in the same manner as in the coating process for the first refractive coating layer 20.

Fifth, formation of the diffusive coating layer 24 over the second low refractive coating layer 21 is carried out (S500).

As shown in FIG. 4f, the process for forming the diffusive coating layer 24 may be achieved by coating a resin composition dispersed with transparent particle 26 over the second low refractive coating layer 21, and curing the coated resin layer.

Sixth, formation of the prism coating layer 25 over the diffusive coating layer 24 is finally carried out (S600).

The process for forming the prism coating layer 25 is achieved by coating the resin composition over the diffusive coating layer 24, pressing a master engraved with a fine pattern having prism structures against the coated resin layer, to transfer the pattern to the coated resin layer, and irradiating UV rays to the pattern-transferred layer, to form a structured pattern.

Practically, prism coating layers 25 each having a fine pattern as described above are arranged such that the fine patterns thereof overlap with each other to be orthogonal to each other are used as an optical member for concentrating light.

In accordance with the above-described processes, an integrated light guide panel, in which the light guide panel 23, reflective coating layer 22, diffusive coating layer 24, and prism coating layer 25 are integrally formed via the low refractive coating layers 20 and 21, is completely formed.

In accordance with the integrated light guide panel manufacturing method according to the present invention, the integrated light guide panel manufactured as described above is completed into a final product after being subjected to a process for cutting the integrated light guide panel into a desired product size.

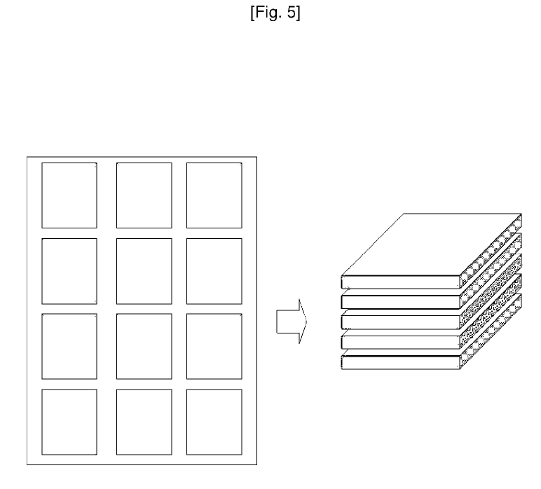

FIG. 5 illustrates a cutting process for cutting the integrated light guide panel manufactured as described above into a certain product size in accordance with the present invention.

Referring to FIG. 5, it can be seen that the light guide panel, which has a large size (for example, a horizontal length of 1,300 mm and a vertical length of 1,600 mm), is cut into a desired product size, for example, a 19-inch product size, to obtain a plurality of products in which the light guide panel and optical film are coupled.

### INDUSTRIAL APPLICABILITY

Thus, in the manufacture of the integrated light guide panel according to the present invention, a large-size light guide panel is first manufactured such that the light guide panel is integral with an optical film, and the manufactured light guide panel is cut into a certain size meeting a product size, different from the conventional case in which a light guide panel is first manufactured separately from an optical film, and assembly of the optical film to the manufactured light guide panel is then carried out.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An integrated light guide panel comprising:
a light guide panel for guiding light, to form surface light;
a reflective coating layer arranged beneath the light guide panel, to reflect light emerging from a lower surface of the light guide panel such that the light is again incident to the light guide panel;
a diffusive coating layer arranged over the light guide panel, to diffuse light emerging from the light guide panel;
a prism coating layer arranged over the diffusive coating layer, to concentrate light emerging from the diffusive coating layer; and
low refractive coating layers respectively arranged between the light guide panel and the reflective coating layer and between the light guide panel and the diffusive coating layer,
the light guide panel being integral with the reflective coating layer, the diffusive coating layer and the prism coating layer.

2. The integrated light guide panel according claim 1, wherein the low refractive coating layers have a refractive index lower than a refractive index of the light guide panel arranged adjacent to the low refractive coating layers.

3. The integrated light guide panel according to claim 1, wherein the low refractive coating layer has a refractive index of about 1.3 to 1.45.

4. The integrated light guide panel according to claim 1, wherein the low refractive coating layers are made of a thermosetting or UV-setting resin selected from a polysiloxane resin, a fluorine-containing polysiloxane resin, trifluoroacrylate, and a silicon-based resin.

5. The integrated light guide panel according to claim 1, wherein each of the low refractive coating layer contains low refractive particulates.

6. The integrated light guide panel according to claim 5, wherein the low refractive particulates are selected from CaF₂, NaF, Na₃AlF₆, SiOₓ, AlF₃, LiF, and MgF₂.

7. The integrated light guide panel according to claim 1, wherein each of the low refractive coating layers has a thickness of about 5 to 30 μm.

8. The integrated light guide panel according to claim 1, wherein the diffusive coating layer contains transparent particulates for scattering light.

9. The integrated light guide panel according to claim 1, further comprising:
a protection film arranged beneath the reflective coating layer or over the prism coating layer.

10. A method for manufacturing an integrated light guide panel, comprising:
performing a printing process on one surface of a light guide panel, to form a light-scattering dot pattern on the surface of the light guide panel;
forming a first low refractive coating layer over the dot pattern printed on the light guide panel;
forming a reflective coating layer over the first low refractive coating layer;
forming a second low refractive coating layer over the other surface of the light guide panel;
forming a diffusive coating layer over the second low refractive coating layer; and
forming a prism coating layer over the diffusive coating layer.

11. The method according to claim 10, further comprising:
cutting the manufactured integrated light guide panel into a predetermined size.

12. The method according to claim 10, wherein the step of forming the refractive coating layer comprises coating a resin composition containing a reflection agent over the first low refractive coating layer.

13. The method according to claim 10, wherein the step of forming the diffusive coating layer comprises coating a resin composition over the second low refractive coating layer, and drying the coated resin composition.

14. The method according to claim 10, wherein the step of forming the prism coating layer comprises coating a resin composition over the diffusive coating layer such that a structured pattern is formed.

15. The method according to claim 10, further comprising:
attaching a protection film to a lower surface of the reflective coating layer or to an upper surface of the prism coating layer.

16. The integrated light guide panel according to claim 2, wherein the low refractive coating layer has a refractive index of about 1.3 to 1.45.

17. The integrated light guide panel according to claim 4, wherein each of the low refractive coating layer contains low refractive particulates.

18. The integrated light guide panel according to claim 17, wherein the low refractive particulates are selected from CaF₂, NaF, Na₃AlF₆, SiOₓ, AlF₃, LiF, and MgF₂.
